(19) United States
(12) Patent Application Publication
(10) Pub. No.: US 2025/0219766 A1
(43) Pub. Date: Jul. 3, 2025

(54) Initial Control Frame Design with Per-User Frame Check Sequence

(71) Applicant: Apple Inc., Cupertino, CA (US)

(72) Inventors: Yan Zhang, Palo Alto, CA (US); Morteza Mehrnoush, Hayward, CA (US); Zhou Lan, San Jose, CA (US); Anuj Batra, Redwood City, CA (US)

(21) Appl. No.: 18/991,265

(22) Filed: Dec. 20, 2024

Related U.S. Application Data
(60) Provisional application No. 63/617,302, filed on Jan. 3, 2024.

(51) Int. Cl. H04L 1/1607; H04L 5/00; H04W 28/18

(52) U.S. Cl. CPC H04L 1/1642; H04L 5/0048; H04W 28/18

(57) ABSTRACT

This disclosure relates to methods for transmitting an initial control frame with pre-padding frame check sequence in a wireless local area network. An initial control frame that includes one or more per-user frame check sequences may be transmitted from an access point to multiple recipient wireless devices. Each per-user frame check sequence may be included in a user info field of the initial control frame corresponding to a recipient wireless device. The recipient wireless device may perform a frame check sequence check for the initial control frame using the per-user frame check sequence.

### PRIORITY INFORMATION

This application claims priority to U.S. provisional patent application Ser. No. 63/617,302, entitled “Initial Control Frame Design with Pre-Padding Frame Check Sequence,” filed Jan. 3, 2024, which is hereby incorporated by reference in its entirety as though fully and completely set forth herein.

### TECHNICAL FIELD

The present application relates to wireless communication, including techniques and devices for using an initial control frame design with pre-padding frame check sequences in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that multiple generations of wireless devices are present. Accommodating such a range of devices, which can have different capabilities with respect to supported packet formats, communication bandwidths, and other features, can require trade-offs with respect to medium use efficiency, throughput, latency, and/or scheduling flexibility, among various considerations. Accordingly, improvements in the field are desired.

### SUMMARY

Embodiments are presented herein of, inter alia, systems, apparatuses, and methods for devices to use an initial control frame design with pre-padding frame check sequences in a wireless local area network architecture.

A wireless device may include one or more antennas, one or more radios operably coupled to the one or more antennas, and a processor operably coupled to the one or more radios. The wireless device (STA) may be configured to establish a connection with an access point (AP) through a wireless local area network (WLAN) over one or multiple wireless links, or may be an access point configured to establish a connection with one or more other wireless devices through a WLAN over one or multiple wireless links. The wireless device may operate in each of the multiple wireless links using a respective radio of the one or more radios.

An access point wireless device may transmit an initial control frame to multiple recipient wireless devices. The initial control frame may include a user info field addressed to each recipient wireless devices, and at least some of the user info fields may include per-user frame check sequences. Such per-user frame check sequences may be provided to recipient wireless devices with padding delay requirements in order to switch channel or operation mode, for example.

A wireless device that receives an initial control frame that requires channel switching (e.g., to a secondary channel operated by the access point wireless device, for enhanced multi-link single radio secondary channel operation or dynamic subband operation, or Non-Primary Channel Access) or operation mode change (e.g., from doze state to awake state in client Power Save operation) and receives a per-user frame check sequence in the user info field of the initial control frame that is addressed to it may perform a frame check sequence check for the initial control frame using its per-user frame check sequence. If the check passes, the wireless device may proceed with channel switching or operation mode switching, potentially without receiving the remainder of the initial control frame and prior to the end of transmission of the initial control frame.

Support for inclusion and use of such per-user frame check sequences in an initial control frame may help improve the medium use efficiency for communications that make use of enhanced multi-link single radio secondary channel operation, dynamic subband operation, non-Primary channel access operation, or client power save operation features. For example, such support may reduce the amount of padding that needs to be included in the initial control frame to meet the padding delay requirements for devices addressed by the initial control frame in operations where pre-Padding FCS (post-FCS padding) is needed, at least according to some embodiments.

The techniques described herein may be implemented in and/or used with a number of different types of devices, including but not limited to cellular phones, tablet computers, accessory and/or wearable computing devices, portable media players, access points, base stations, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a flowchart diagram illustrating an example method for transmitting an initial control frame with per user frame check sequences in a wireless local area network, according to some embodiments;

FIG. 5 illustrates example aspects of a possible wireless communication scenario in which an initial control frame configures a wireless device for enhanced multi-link single radio (EMLSR) secondary channel (SC) operation or dynamic subband operation (DSO), according to some embodiments;

FIG. 6 illustrates example aspects of a possible scenario in which some of the user info fields of an initial control frame can be used to meet the padding delay value required for a wireless device in operations not requiring pre-Padding FCS check such as regular EMLSR operation, according to some embodiments;

FIG. 7 illustrates example aspects of a possible scenario in which the user info fields of an initial control frame cannot be used to meet the padding delay value required for a wireless device in operations where padding bits are needed to switch channel or operation mode, according to some embodiments;

FIG. 8 illustrates example aspects of a possible initial control frame that includes per-user frame check sequences, according to some embodiments;

FIGS. 9-10 illustrate example aspects of various possible approaches to generating per-user frame check sequences for inclusion in an initial control frame, according to some embodiments; and

FIGS. 11-14 illustrate example aspects of various possible approaches to providing an intermediate frame check sequence in an initial control frame, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which may reside in different locations, e.g., in different computer systems that are connected over a network. The memory medium can store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a user equipment device or in a network infrastructure device. Processors may include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11.b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

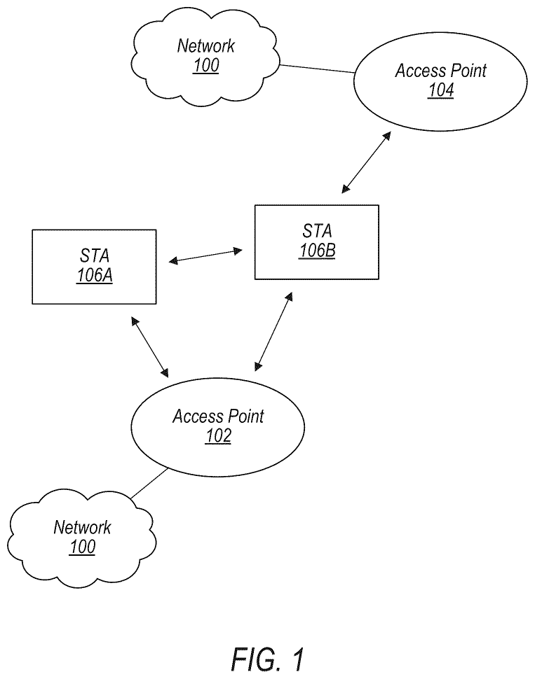

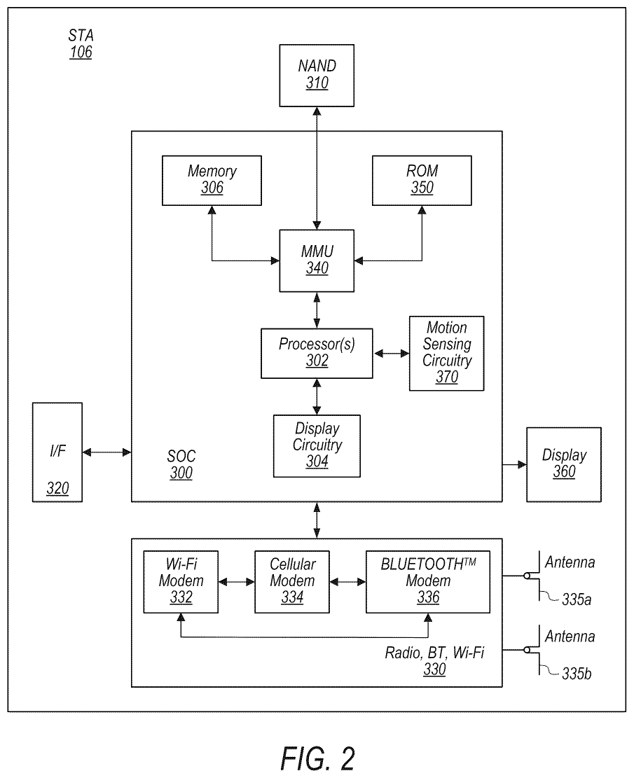

### FIGS. 1-2—Wireless Communication System

FIG. 1 illustrates an example of a wireless communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the exemplary wireless communication system includes an access point (AP) 102, which communicates over a transmission medium with one or more wireless devices 106A, 106B, etc. Wireless devices 106A and 106B may be user devices, such as stations (STAs), non-AP STAs, UEs, or other WLAN devices.

The STA 106 can be a device with wireless network connectivity such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any type of wireless device. The STA 106 can include a processor (processing element) that is configured to execute program instructions stored in memory. The STA 106 can perform any of the method embodiments described herein by executing one or more of such stored instructions. Alternatively, or in addition, the STA 106 may include a programmable hardware element such as an FPGA (field-programmable gate array), an integrated circuit (e.g., an ASIC), and/or any of various other possible hardware components that are configured to perform (e.g., individually or in combination) any of the methods described herein, or any portion of any of the methods described herein.

The access point 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. In other implementations, AP 102 can be configured to provide communications over one or more other wireless technologies, such as any, any combination of, and/or all of 802.11a, b, g, n, ac, ad, ax, ay, be and/or other 802.11 versions, and/or a cellular protocol, such as 6G, 5G, and/or LTE, including in an unlicensed band.

The communication area (or coverage area) of the AP 102 can be referred to as a basic service area (BSA) or cell. The AP 102 and the STAs 106 may be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system also includes an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communications capability. For example, one or more of the STAs 106A and 106B can be a wireless device intended for stationary or nomadic deployment such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication may be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of the method embodiments described herein by executing instructions on one or more programmable processors. For example, the STA 106 can be configured to perform techniques for using an initial control frame design with one or more pre-padding frame check sequences in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some embodiments, the STA device 106 can be configured to communicate using a single shared radio. The shared radio may couple to a single antenna, or may couple to multiple antennas (e.g., for MIMO) for performing wireless communications. Alternatively, the STA device 106 may include two or more radios, each of which can be configured to communicate via a respective wireless link. Other configurations are also possible.

### FIG. 2—Example Block Diagram of a STA Device

FIG. 2 illustrates one possible block diagram of a STA device, such as STA device 106. In some instances, the STA 106 can additionally or alternatively be referred to as a UE 106. STA 106 also can be referred to as a non-AP STA 106. As shown, the STA device 106 can include a system on chip (SOC) 300, which can include portions for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 300 can include processor(s) 302, which can execute program instructions for the STA 106, and display circuitry 304, which can perform graphics processing and provide display signals to the display 360. The SOC 300 can also include motion sensing circuitry 370, which can detect motion of the STA 106 in one or more dimensions, for example using a gyroscope, accelerometer, and/or any of various other motion sensing components. The processor(s) 302 can also be coupled to memory management unit (MMU) 340, which can be configured to receive addresses from the processor(s) 302 and translate those addresses to locations in memory (e.g., memory 306, read only memory (ROM) 350, flash memory 310). The MMU 340 can be configured to perform memory protection and page table translation or set up. In some embodiments, the MMU 340 can be included as a portion of the processor(s) 302.

As shown, the SOC 300 can be coupled to various other circuits of the STA 106. For example, the STA 106 can include various types of memory (e.g., including NAND flash 310), a connector interface 320 (e.g., for coupling to a computer system, dock, charging station, etc.), the display 360, and wireless communication circuitry 330 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some embodiments multiple antennas 335a and 335b, for performing wireless communication with access points, base stations, wireless stations, and/or other devices. For example, the STA 106 can use antennas 335a and 335b to perform the wireless communication. As noted above, the STA 106 can, in some examples, be configured to communicate wirelessly using a plurality of wireless communication standards or radio access technologies (RATs).

The wireless communication circuitry 330 can include a Wi-Fi modem 332, a cellular modem 334, and a Bluetooth modem 336. Note that one or more of the Wi-Fi modem 332, the cellular modem 334, and/or the Bluetooth modem 336 can be configured for MLO, e.g., as described above. The Wi-Fi modem 332 is for enabling the STA 106 to perform Wi-Fi or other WLAN communications, e.g., on an 802.11 network. The Bluetooth modem 336 is for enabling the STA 106 to perform Bluetooth communications. The cellular modem 334 can be capable of performing cellular communication according to one or more cellular communication technologies, e.g., in accordance with one or more 3GPP specifications.

As described herein, STA 106 can include hardware and software components for implementing embodiments of this disclosure. For example, one or more components of the wireless communication circuitry 330 (e.g., Wi-Fi modem 332, cellular modem 334, BT modem 336) of the STA 106 can be configured to implement part or all of the methods for using an initial control frame with pre-padding frame check sequence(s) described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

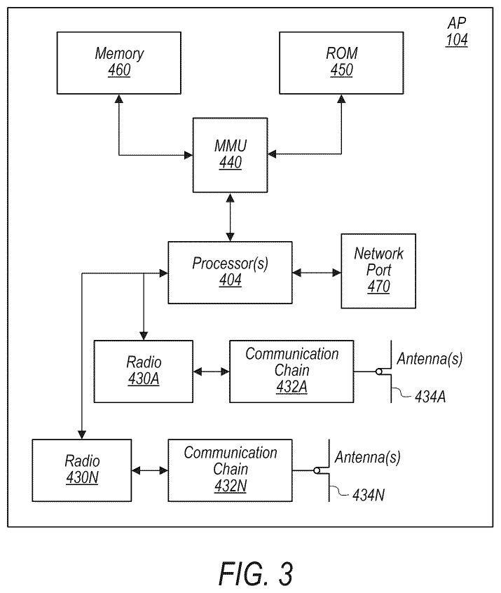

### FIG. 3—Block Diagram of an Access Point

FIG. 3 illustrates an example block diagram of an access point (AP) 104, according to some embodiments. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 404, which can execute program instructions for the AP 104. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 470. The network port 470 can be configured to couple to a network and provide multiple devices, such as STA devices 106, with access to the network, for example as described herein above in FIG. 1.

The network port 470 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 470 can couple to a telephone network via the core network, and/or the core network can provide a telephone network (e.g., among other STA devices serviced by the cellular service provider).

The AP 104 may include one or more radios 430A-430N, which can be coupled to one or more respective communication chains and at least one antenna 434, and possibly multiple antennas. The antenna(s) 434 can be configured to operate, in conjunction with one or more other components, as a wireless transceiver and can be further configured to communicate with STA devices 106 via radio 430. Note that one or more of the radios 430A-430N can be configured for MLO, e.g., as described herein above. The antenna(s) 434A-N communicate with one or more respective radios 430A-N via communication chains 432A-N. Communication chains 432 can be receive chains, transmit chains, or both. The radios 430A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 430A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as using an initial control frame design with pre-padding frame check sequence(s), among various other possible features. The processor 404 of the access point 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 404 can be configured as a programmable hardware element, such as an FPGA (Field Programmable Gate Array), or as an ASIC (Application Specific Integrated Circuit), or a combination thereof. Alternatively (or in addition) the processor 404 of the AP 104, in conjunction with one or more of the other components 430, 432, 434, 440, 450, 460, 470 can be configured to implement or support implementation of part or all of the features described herein.

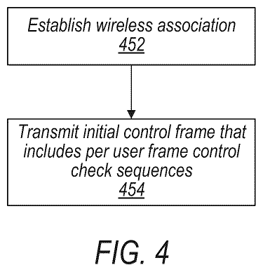

FIG. 4—Transmitting an Initial Control Frame with Per-User Frame Check Sequences

Wi-Fi communication systems can include multiple generations of wireless devices, for example potentially including devices associated with 6th generation Wi-Fi (“Wi-Fi 6,” “Wi-Fi 6E,” “high efficiency,” or “HE” devices, e.g., including those that operate based on IEEE 802.11ax), devices associated with 7th generation Wi-Fi (“Wi-Fi 7,” “extremely high throughput” or “EHT” devices, e.g., including those that operate based on IEEE 802.11be), and/or devices associated with 8th generation Wi-Fi (“Wi-Fi 8,” “ultra-high reliability” or “UHR” devices, e.g., including those that operate based on the specifications established by the UHR IEEE 802.11 working group), among various possibilities.

Some such wireless devices can be capable of operating on a secondary channel associated with an AP wireless device, even though those wireless devices may not be capable of operating on the full bandwidth of the AP wireless device at any given time, for example using enhanced multi-link single radio (EMLSR) secondary channel (SC) operation and/or dynamic subband operation (DSO) techniques. Some such wireless devices may prefer to operate on low power listen mode with 1 RF chain, support receiving only on 20 MHz bandwidth and/or low MCS transmission, and only switch to full power transmit/receive mode with multiple RF chains, full bandwidth and full set of MCS support if initiated by AP, for example in client Power Save operation. To support such operations, at least in some instances, it can be the case that an initial control frame (ICF), such as a multi-user request-to-send (MU-RTS) frame or a buffer status report poll (BSRP) frame or a bandwidth queue report poll (BQRP), is used to provide user information to such a wireless device indicating a resource assignment for the wireless device on the secondary channel for an upcoming communication window (e.g., an upcoming TXOP in IEEE 802.11 standards), or to indicate to the wireless device to switch from lower power listen mode to full power transmit/receive mode. The wireless device may then be able to perform a channel switch to the secondary channel or switch from lower power listen mode to full power transmit/receive mode to perform communication with the AP wireless device during that communication window.

Such channel switching or operation mode switching can require a certain amount of time for the wireless device. The wireless device can also need to verify the integrity of the ICF, for example by performing a frame check sequence (FCS) check for the ICF, before proceeding to perform the channel switch or operation mode switch. Thus, if the FCS is placed at the end of the ICF, an EMLSR-SC operation/DSO wireless device, a non-Primary channel access operation device, or a power save operation device can be forced to wait until the end of the ICF to begin performing the channel switching or operation mode switching, which can in turn disrupt data communication initiated by the ICF due to delayed initial response. Accordingly, an alternative ICF design that can support earlier channel or operation mode switching initiation by an EMLSR-SC operation/DSO wireless device, a non-Primary channel access operation wireless device, or a power save operation wireless device may have the potential to improve channel efficiency, reduce power consumption, and/or otherwise benefit wireless devices in a wireless communication system, at least according to some embodiments.

FIG. 4 is a flowchart diagram illustrating a method for supporting transmission and reception of such an initial control frame that includes per user frame check sequences in a WLAN, according to some embodiments. In various embodiments, some of the elements of the method shown may be performed concurrently, in a different order than shown, may be substituted for by other method elements, or may be omitted. Additional method elements may also be performed as desired.

Aspects of the method of FIG. 4 can be implemented by a wireless device, such as the AP 104 or STA 106 illustrated in and described with respect to FIGS. 1-3, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the method of FIG. 4 are described in a manner relating to the use of communication techniques and/or features associated with IEEE 802.11 specification documents, such description is not intended to be limiting to the disclosure, and aspects of the method of FIG. 4 may be used in any suitable wireless communication system, as desired. As shown, the method may operate as follows.

At least two wireless devices (which can also be referred to herein as “wireless stations,” “stations,” or “STAs”) can establish a wireless association (452). The wireless association(s) may be established using Wi-Fi, wireless communication techniques that are based at least in part on Wi-Fi, and/or any of various other wireless communication technologies, according to various embodiments. For example, an access point (AP) wireless device can provide beacon transmissions including information for associating with the AP wireless device, and one or more other wireless devices (e.g., non-AP wireless devices) can request to associate with the AP wireless device using the information provided in the beacon transmissions, as one possibility. Variations and/or other techniques for establishing an association are also possible.

The AP wireless device can provide wireless local area network functionality to associated wireless devices, at least according to some embodiments. As part of the wireless local area network functionality, it can be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

The AP wireless device can perform a downlink transmission to multiple recipient (destination) wireless devices with which it has formed associations. At least according to some embodiments, the AP wireless device can contend for medium access (e.g., to avoid collisions and potential interference), and, once medium access is obtained, transmit an initial control frame (ICF) to the destination wireless devices (454). As one example, the ICF could include a multi-user request-to-send (MU-RTS) frame.

The ICF can include one or more per-user FCSs. A per-user FCS can be provided to all destination wireless devices addressed by the ICF, or to a subset of those wireless devices. In some embodiments, only certain destination wireless devices are provided with per-user FCSs. For example, certain devices, such as ultra high reliable (UHR) onward wireless devices can be provided with per-user FCSs. Furthermore, certain devices, such as EMLSR-SC operation, DSO, Non-Primary channel access operation, or Power Save operation wireless devices, can benefit from inclusion of a corresponding per-user FCS, while other devices, such as at least some legacy devices, may not understand or be able to use such per-user FCSs. Accordingly, in some embodiments, the AP can select a subset of destination wireless devices of the ICF for which to include a per-user FCS. The subset can be selected based at least in part on which destination wireless devices of the ICF are UHR onward generation wireless devices, EMLSR-SC operation, DSO, Non-Primary channel access operation, and/or Power Save operation wireless devices (e.g., the AP can determine to include a per-user FCS for each UHR onward generation wireless device, each EMLSR-SC operation/DSO, Non-Primary channel access operation, and/or Power Save operation wireless device among the destination wireless devices of the ICF based at least in part on their EMLSR-SC operation/DSO, Non-Primary channel access operation, or Power Save operation status, as one possibility), and/or based on any of various other possible considerations, according to various embodiments.

In some embodiments, each respective per-user FCS can be included in a respective user info field of the ICF corresponding to a respective destination wireless device of the ICF. In other words, the user info field of the ICF that is addressed to a given wireless device can also include the per-user FCS for that wireless device, if a per-user FCS is being provided to that wireless device. For example, in some embodiments, each user info field of the ICF can be 5 bytes, and 16 bits out of those 5 bytes can be used for a 2 byte per-user FCS. The contents of the ICF (e.g., the frame body field) up to each respective per-user FCS can be used to calculate the respective per-user FCS. Thus, continuing the preceding example, all preceding fields of the ICF and 24 bits (e.g., 23 least significant bits plus the most significant bit) of a given user info field for a given user can be used to calculate the per-user FCS that is included in that user info field for that user.

The per-user FCS(s) can be generated in any of a variety of possible ways. As one possibility, the per-user FCS(s) can be generated using a generator polynomial of degree 32. If 2 bytes is allotted for each per-user FCS, as in the preceding example, 2 bytes can be extracted from the 4 byte output of such a generator polynomial to use as the per-user FCS. The 2 bytes can be extracted in any of various ways; for example, the first 2 bytes, the last 2 bytes, the middle 2 bytes, the first byte and the last byte, or any of various other options can be used to extract 2 bytes from the 4 byte output, as desired.

As another possibility, the per-user FCS(s) can be generated using a generator polynomial of degree 16. In this case, if 2 bytes is allotted for each per-user FCS, as in the preceding example, the 2 byte output of such a generator polynomial can directly be used as the per-user FCS, at least as one possibility.

Note that each per-user FCS can be part of the contents of the ICF that are used to calculate each subsequent per-user FCS that is included in the ICF. At least according to some embodiments, the ICF can also include a final FCS, for example to accommodate legacy wireless devices and/or wireless devices that are not currently utilizing a Padding field of the ICF to switch channel or operation mode. The full contents of the ICF up to the final FCS, including the one or more per-user FCSs, can be used to calculate the final FCS for the ICF.

The ICF, including the one or more per-user FCSs, can be received by each of the recipient wireless devices addressed by the ICF. If the user info field addressed to that wireless device includes a per-user FCS, the wireless device can perform an FCS check for the ICF using the per-user FCS in the user info field addressed to the wireless device. The FCS check for the ICF can be performed using the contents of the ICF up to the per-user FCS included in the user info field of the ICF corresponding to the wireless device, and may not use any contents of the ICF after that user info field. If the per-user FCS check passes (e.g., if the received per-user FCS value matches a per-user FCS value calculated by the wireless device for the portion of the ICF protected by the per-user FCS), and the wireless device needs to perform a channel switch (e.g., based on the resource unit allocation for the wireless device indicated in the user info field for the wireless device) or operation mode switch (e.g. from low power listen mode to full power transmit/receive mode), the wireless device can begin performing channel switching or operation mode switching without waiting for the remainder of the ICF to be received, at least according to some embodiments.

The ICF can be communicated using non-high throughput (non-HT) duplication (DUP) across the operating bandwidth of the AP wireless device, at least in some embodiments. As this can include the ICF being repeated in each 20 MHz of the AP operating bandwidth, this can help enable wireless devices of different generations, including those with smaller operating bandwidth capability than the operating bandwidth of the AP wireless device, to successfully receive and decode the ICF.

At least in some embodiments, the recipient wireless devices can respond to the ICF, e.g., to confirm reception of the ICF and availability to receive the following downlink PPDU; for example, a clear-to-send (CTS) frame can be provided by each of the recipient wireless devices (e.g., on their corresponding assigned resource allocation) in response to a MU-RTS frame, or a buffer status report (BSR) frame can be provided by each of the recipient wireless devices (e.g., on their corresponding assigned resource allocation) in response to a BSRP frame. The downlink frame can be transmitted by the AP wireless device after reception of this initial response (IR) frame (e.g., the CTS or BSR).

Note that similar techniques may be used for ICF transmission to arrange uplink frames, and/or other types of communication, according to various embodiments. For example, after transmitting the ICF and receiving IR frames from the recipient wireless devices according to the techniques described herein, the AP wireless device can transmit a trigger frame to solicit an uplink frame. The AP wireless device can then receive the configured uplink frame from the transmitting wireless device(s). At least in some embodiments, transmission of a block acknowledgement (BA) frame can follow after uplink or downlink data frame transmission, possibly after solicitation of the BA frame by a BA request (BAR) frame.

Inclusion of one or more per-user FCS values in a ICF for a wireless device that needs a certain amount of switch delay to perform channel switching or operation mode switching before the following frame (e.g., transmission of an IR using the resource assignment provided for the wireless device in the ICF, as one possibility) can help reduce the amount of padding needed to provide the switch delay, according to some embodiments. In particular, it can be possible for the AP to order the user info fields included in the ICF based at least in part on the user padding delay requirements (e.g., in descending order of user padding delay requirements) for the wireless devices addressed by the ICF. The AP can additionally calculate the amount of padding for the ICF based on the use of the per-user FCSs and the reported user padding delay requirements for the wireless devices addressed by the ICF, for example such that any user info fields following the user info field for a given wireless device that includes a per-user FCS can count toward the user padding delay requirement for that wireless device.

When receiving the ICF, correspondingly and as previously noted, such a wireless device can start performing channel switching immediately or soon after the user info field addressed to the wireless device (e.g., provided the per-user FCS check passes), without waiting for the remainder of the user info fields of the ICF, any subsequent padding, or the final FCS for the ICF, such that the remainder of the user info fields can contribute to meeting the user padding delay requirement for the wireless device.

Thus, according to the method of FIG. 4, it can be possible to communicate an initial control frame with per user frame check sequences, which can potentially reduce the amount of padding used to support devices that need to perform channel switching or operation mode switching in response to the initial control frame, and thus can improve medium use efficiency, among other possible benefits, at least according to some embodiments.

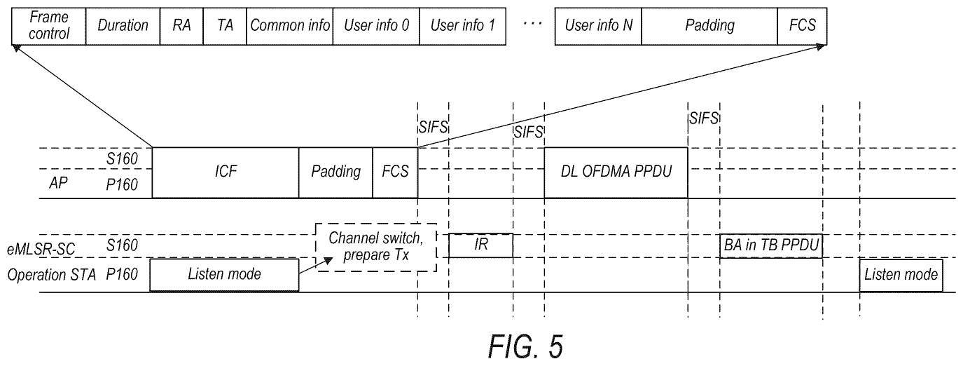

### FIGS. 5-14 and Additional Information

FIGS. 5-14 illustrate further aspects that might be used in conjunction with the method of FIG. 4 if desired. It should be noted, however, that the exemplary details illustrated in and described with respect to FIGS. 5-14 are not intended to be limiting to the disclosure as a whole: numerous variations and alternatives to the details provided herein below are possible and should be considered within the scope of the disclosure.

In IEEE 802.11 deployments, it may be the case that an AP can support a larger bandwidth than at least some STAs. For example, it may be the case that 802.11ax APs support 160 MHz bandwidth use, while non-AP STAs support up to 80 MHz bandwidth use. Utilizing the upper 80 MHz (secondary channel) provided by an AP may improve the quality of service (QOS) for a STA.

It may be possible to leverage enhanced multi-link single radio (EMLSR) to support STA operation on the secondary channel (SC). Such operation may be referred to as EMLSR-SC and/or as dynamic subband operation (DSO), according to various embodiments. EMLSR techniques may be supported in enhanced high throughput (EHT) systems, and may enable switching channels/bands based on an initial control frame (ICF). An ICF may be used to inform an EMLSR-SC operation/DSO capable STA to switch to the secondary channel. An initial response (IR) frame from the STA may indicate that the STA has switched channels, and is ready for downlink (DL)/uplink (UL) operation.

Media access control (MAC) frames may conventionally include a frame check sequence (FCS) field appended at the end of the frame. The FCS field value may be calculated over all of the fields of the MAC header and the Frame Body field. The FCS field value may be used to check whether the frame has been correctly decoded.

In EMLSR operation, to satisfy scheduled STA channel (band) switch delay requirement, padding bits may be appended after the last user info field in the initial control frame. The FCS field may be added after the padding field. Using the FCS with this frame structure may be possible in EMLSR operation where channel switching is not needed (e.g., STA only needs to transmit the initial response on the channel where ICF is received), at least in some embodiments. However, in EMLSR-SC operation when a STA only listens on the primary channel with one radio, as shown in FIG. 5, it may be possible that the EMLSR-SC operation STA cannot switch to the secondary channel after parsing the user info field with matching AID12 (e.g., a value indicating the 12 least significant bits of an association identifier) without FCS check. In this case, even if the padding field satisfies EMLSR-SC operation STAs' switch padding delay requirement, it may not be useful for those STAs, e.g., because the FCS is not received until after the padding field.

EMLSR padding delay indicated by a non-AP multi-link device (MLD) may be the minimum MAC padding duration of the ICF that the AP MLD uses for the initial frame exchange with the non-AP MLD on one of the EMLSR links. When an AP transmits an ICF that initiates frame exchanges with more than one non-AP MLD in EMLSR mode, the AP may ensure that the length of the padding field of the ICF is calculated based on rules in “Padding for a trigger frame” to ensure that the MAC padding duration of the ICF is greater than or equal to the maximum of the EMLSR padding delay values received from the non-AP MLDs to which the ICF is sent. In some instances, it may be the case that the AP shall ensure that the number of bits in the physical layer services data unit (PSDU) following the last bit of the User Info field addressed to the non-AP MLD is at least:

$${L}_{PAD , MAC} = {N}_{DBPS} \cdot {m}_{PAD} ,$$

where N_{DBPS} is the number of data bits in one orthogonal frequency division multiplexing (OFDM) symbol, and

$${m}_{PAD} = \{ \begin{matrix}0 , if EMLSR - PADDING - DELAY is 0 \\ {2}^{EMLSR - PADDING - DELAY + 2} , Otherwise\end{matrix}$$

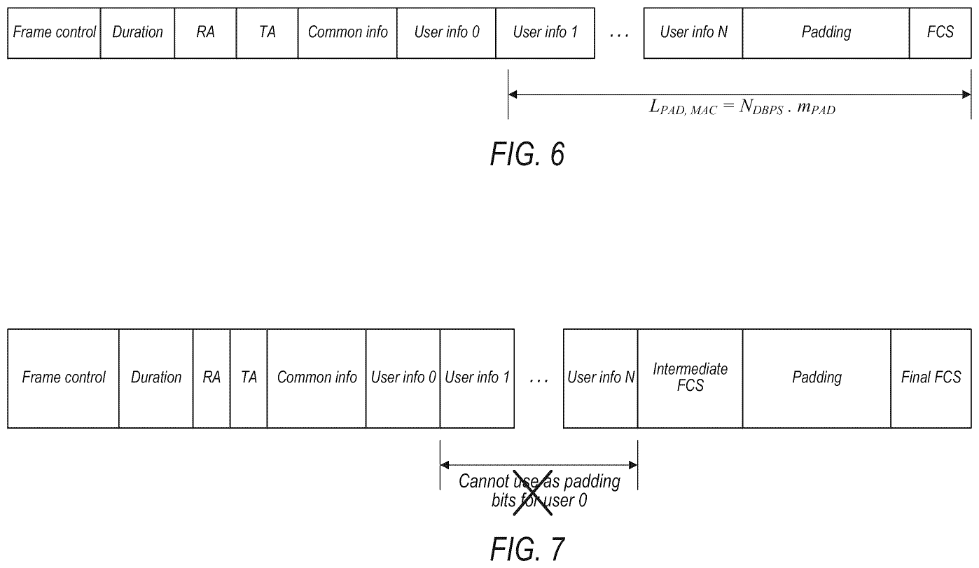

For example, the padding bits for User 0 may start from the end of User Info field 0, as shown in FIG. 6. However, if User 0 is an EMLSR-SC STA, it may be the case that channel switch cannot be started until FCS check is finished, so in such a case the padding does not help the User 0 for switching to the secondary channel.

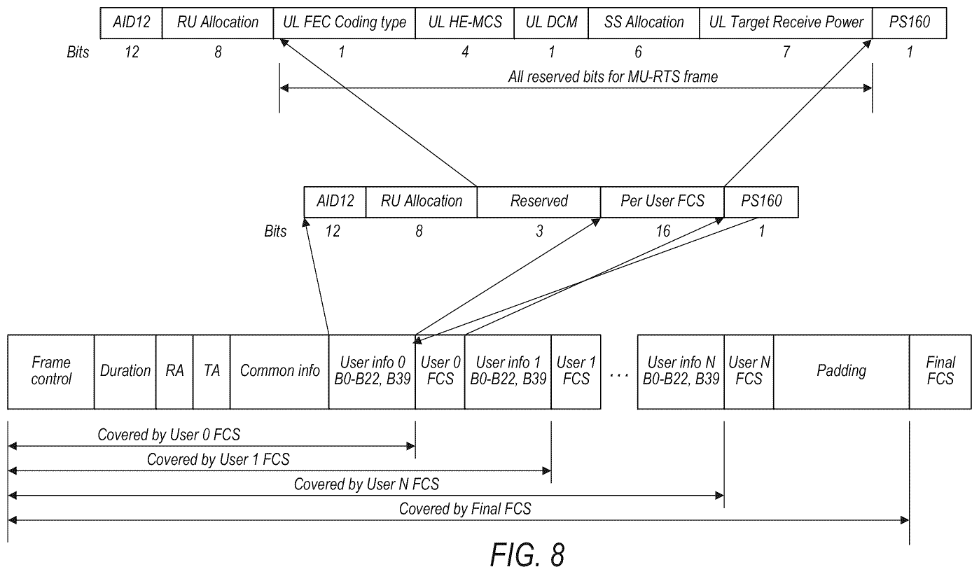

One possibility for addressing this FCS check scenario in operations which require pre-Padding FCS check such as EMLSR-SC/DSO operation, non-Primary channel access operation, or client power save operation, may include use of an intermediate FCS field. EMLSR-SC/DSO operation, Non-Primary channel access operation, or client Power Save operation STAs may check the intermediate FCS field and switch to the secondary channel or perform the operation mode switch afterward. Legacy STAs may still use the final FCS field for performing the FCS check. The intermediate FCS may include 4 bytes and use the same generation polynomial as the final FCS field, as one possibility. Two special user info fields (assigned with a predetermined AID12) may contain the 4 bytes intermediate FCS field. FIG. 7 illustrates aspects of an example frame that includes such an intermediate FCS field, according to some embodiments.

In some embodiments, it may be possible that STAs can have padding delay values of 0, 32, 64, 128, and 256 μs. To reduce padding overhead, the AP may arrange the user info fields with STAs' padding requirements in a descending order, since the following user info fields can be part of the padding for STAs addressed in the previous user info fields. If an ICF is transmitted at 6 Mbps, for example, each user info field duration may be 6⅔ μs, such that for an ICF including 16 scheduled STAs, the duration between the User Info field 0 and the Intermediate FCS field is approximately 100 μs.

However, all STAs requiring pre-Padding FCS check, such as EMLSR-SC operation/DSO, non-Primary channel access operation, or client power save operation STAs may have to wait to decode the intermediate FCS field before switching to the secondary channel even if their individual User Info Field is decoded and ready to switch. Thus, the Padding field duration alone may need to be sufficient to satisfy the maximum of the padding delay requirements received from the non-AP MLDs. As an example, it may be the case that User Info fields 1-N cannot be used as part of the padding to satisfy the padding delay requirement for User 0, in this case.

In multi-user request to send (MU-RTS) frames, each user info field may contain 5 bytes payload. It may be the case that only 21 bits (the 20 least significant bits (LSBs) and the most significant bit (MSB)) are defined and the remaining 19 bits are reserved. Accordingly, it may be possible to redefine 16 of the reserved bits in the user info field to include a 2 bytes per User FCS value. Each per User FCS may check all of the fields of the MAC header and the frame body field up to the 24 bits payload within the same user info field. This option may enable an EMLSR-SC operation/DSO, Non-Primary channel access operation, or client power save operation STA to switch right after decoding the user info field with matching AID12, making the ICF padding field length more efficient while meeting non-AP MLD padding delay requirements. For example, in an ICF with 16 scheduled STAs, if user 0 (e.g., an EMLSR-SC operation/DSO, Non-Primary channel access operation, or client power save operation STA) padding delay requirement is 256 μs, and the rest of the users' padding delay requirement is less than or equal to 128 μs, the per user FCS approach can save 100 us in the Padding field in comparison to the Intermediate FCS approach (e.g., in a scenario in which the ICF is transmitted at 6 Mbps). The more STAs with various padding delay requirements that are included in the ICF, the larger the overhead saving may be in comparison to the Intermediate FCS approach, at least according to some embodiments.

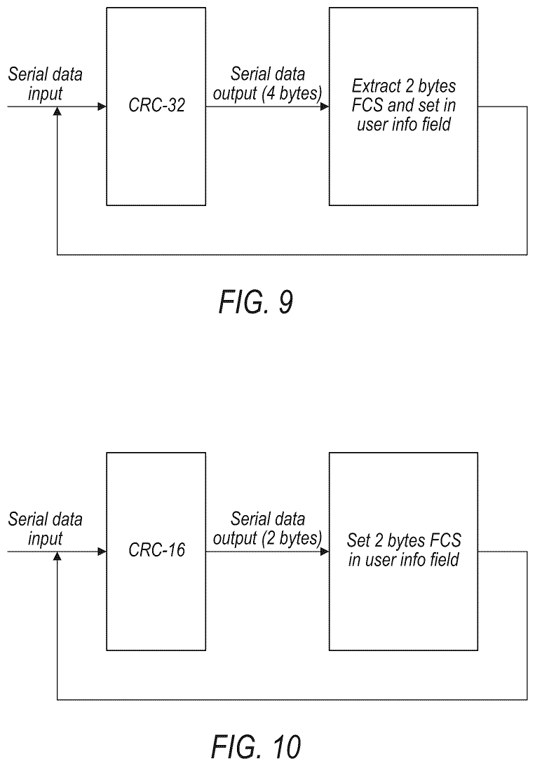

FIG. 8 illustrates aspects of an example MU-RTS frame that can be used as an ICF and that includes per user FCS information, according to some embodiments. Note that it may be possible that per user FCS is only added to the user info fields which are addressed to UHR onward STAs, EMLSR-SC operation/DSO, Non-Primary channel access operation, and/or client power save operation STAs. Such information may not be needed for legacy (e.g., HE/EHT) STAs scheduled in the ICF. In the illustrated example, it may be the case that user 0, 1, and N are UHR onward STAs, EMLSR-SC operation/DSO, Non-Primary channel access operation, and/or client power save operation STAs. As shown, the User 0 FCS may check all of the fields of the MAC header and the frame body field up to the payload in User info 0 field (e.g., B0-B22 and B39). The User 1 FCS may check all of the fields of the MAC header and the frame body field up to the payload in User info 1 field (e.g., B0-B22 and B39). The User N FCS may check all of the fields of the MAC header and the frame body field up to the payload in User info N field (e.g., B0-B22 and B39). The final FCS may check all of the fields of the MAC header and the frame body field up to the end of the Padding field. Legacy STAs may check the Final FCS.

There may be multiple options for generating a 2 bytes per User FCS value. As one option, a standard generator polynomial of degree 32 may be used to generate a 4 bytes FCS value (e.g., as for the Final FCS), and 2 of the resulting 4 bytes may be used to set the per User FCS for each user info field assigned to UHR onward STAs, EMLSR-SC operation/DSO, Non-Primary channel access operation, and/or client power save operation STAs. For example, the last two bytes of the four bytes could be used, or the first two bytes, or any other combination of two bytes of the four bytes, as desired. As another option, a standard generator polynomial of degree 16 may be used to generate a 2 bytes FCS value, for example as for direct sequency spread spectrum (DSSS) PHY protection and/or wake-up radio (WUR) frames cyclic redundancy check (CRC). For both options, it may be the case that the 16 CRC bits set in the per User FCS field are used as part of the user info field payload to generate the remaining FCS fields, including the Final FCS field.

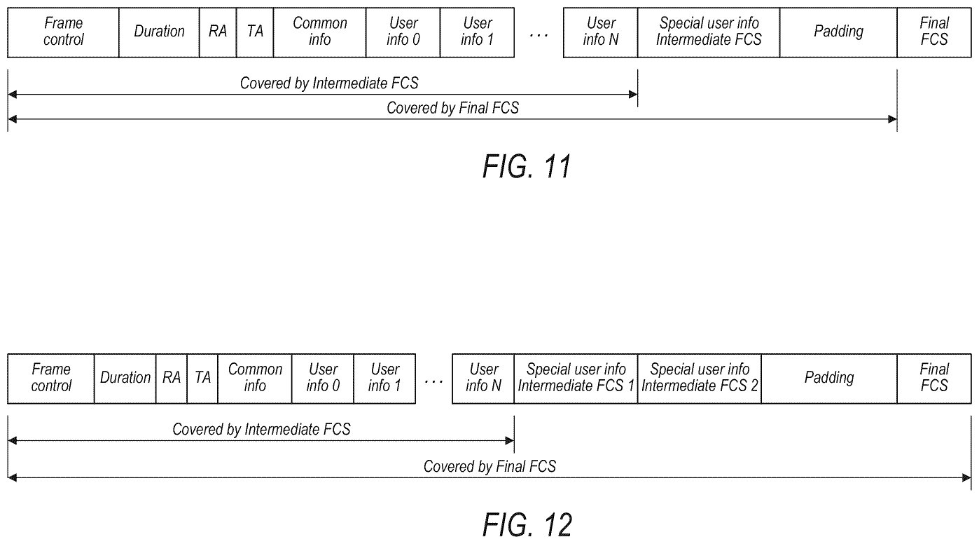

FIG. 9 illustrates example aspects of an approach using CRC-32, according to some embodiments. The CRC-32 generation may use the same implementation as used to calculate the final FCS field value, in some embodiments. After each User Info field payload (e.g., B0-B22 and B39) input, 2 bytes out of the 4 bytes FCS output may be extracted and used to set the value in the corresponding per User FCS field. These 16 bits (e.g., B23-B38) may then be fed back to the input of the CRC-32 as part of the data input to calculate the remaining FCS fields, e.g., as shown in FIG. 8. The AP may only need to add this step for user info fields addressed to UHR onward STAs, EMLSR-SC operation/DSO, Non-Primary channel access operation, and/or client power save operation STAs, in some embodiments. For an UHR onward STA, EMLSR-SC operation/DSO, Non-Primary channel access operation, and/or client power save operation STA, a per User FCS check may be performed if the AID12 value for a User Info field matches its own AID, and the STA may switch to the assigned secondary channel or switch from lower power listen mode to full power transmit/receive mode after the FCS check passes.

FIG. 10 illustrates example aspects of an approach using CRC-16, according to some embodiments. The CRC-16 used to calculate the FCS may be the same as used in WUR frame FCS. After each User Info field payload (e.g., B0-B22 and B39) input, the 2 bytes output may be used to set the value in the corresponding per User FCS field. These 16 bits (e.g., B23-B38) may then be fed back to the input of the CRC-16 as part of the data input to calculate the remaining FCS fields, e.g., as shown in FIG. 8. The AP may only need to add this step for user info fields addressed to UHR onward STAs, EMLSR-SC operation/DSO, Non-Primary channel access operation, and/or client power save operation STAs, in some embodiments. For a UHR onward STA, an EMLSR-SC operation/DSO, Non-Primary channel access operation, and/or client power save operation STA, a per User FCS check may be performed if the AID12 value for a User Info field matches its own AID, and the STA may switch to the assigned secondary channel or switch from lower power listen mode to full power transmit/receive mode after the FCS check passes. Additionally, the AP may need to feed the data input bit stream to the CRC-32 for final FCS calculation.

For ICF using buffer status report poll (BSRP) or bandwidth queue report poll (BQRP) frames, there may not be sufficient reserved bits in the user info field to be repurposed as a per User FCS field. In this case, it may be possible that pre-Padding Intermediate FCS is used for operations that require pre-Padding FCS check. In this option, the Padding field plus the final FCS field may be used to meet the padding delay required by UHR onward STAs, EMLSR-SC operation/DSO, Non-Primary channel access operation, and/or client power save operation STAs. A special user info field with predetermined AID12 (e.g., any reserved AID12 values for HE/EHT STAs, as one possibility) can be used to indicate the start of the intermediate FCS.

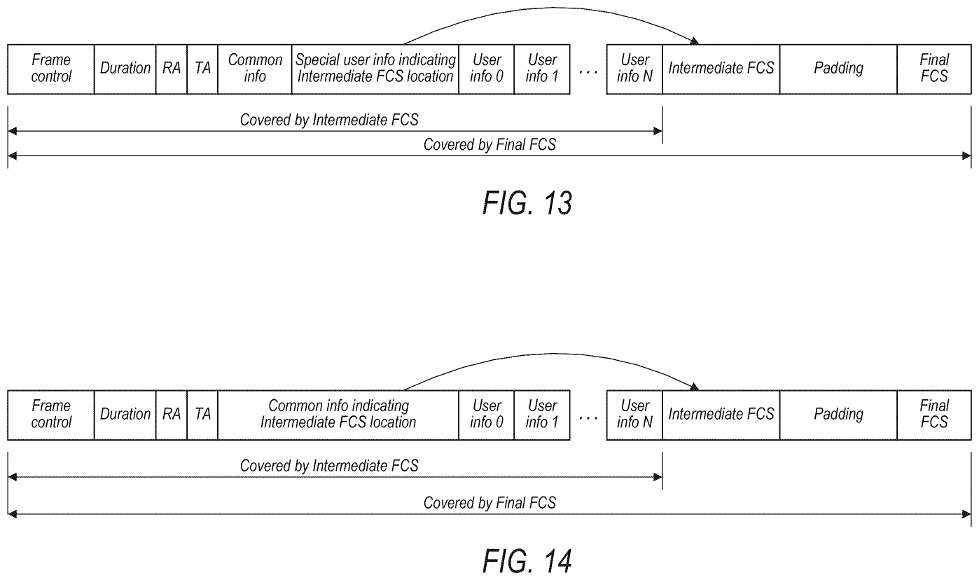

FIG. 11 illustrates aspects of one possible way of constructing a BSRP frame using such an Intermediate FCS, according to some embodiments. In the illustrated scenario, one special user info field may be used to carry the Intermediate FCS. Since each User Info field may be 5 bytes, as one such possibility, 3 bytes out of a 4 bytes FCS generated using CRC-32 may be used as the Intermediate FCS. As another such possibility, CRC-16 may be used to generate a 2 bytes FCS as the Intermediate FCS.

FIG. 12 illustrates another possible way of constructing a BSRP frame using such an Intermediate FCS, according to some embodiments. In the illustrated scenario, a 4 bytes FCS generated using CRC-32 may be used as the Intermediate FCS, and the Intermediate FCS value may be split into two special user info fields with the same AID12 (e.g., since the FCS may be 4 bytes, the AID12 may be 12 bits, and each User Info field may be 5 bytes).

FIG. 13 illustrates yet another possible way of constructing a BSRP frame using such an Intermediate FCS, according to some embodiments. In the illustrated scenario, the Intermediate FCS location may be indicated in a special user info field immediately after the Common info field. For example, the indication may be of the number of user info fields after the special user info field that contains the Intermediate FCS value. In this case, no special user AID12 may be needed, and it may be the case that only the 4 bytes FCS value is appended immediately after the last User info field.

FIG. 14 illustrates still another possible way of constructing a BSRP frame using such an Intermediate FCS, according to some embodiments. In the illustrated scenario, the Intermediate FCS location may be indicated in the Common Info field. For example, the indication may be of the number of user info fields after the Common Info field that contains the Intermediate FCS value. In this case, no special user AID12 may be needed, and it may be the case that only the 4 bytes FCS value is appended immediately after the last User info field.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
transmitting, to a plurality of wireless devices, an initial control frame (ICF) comprising one or more per-user frame check sequences (FCSs).

2. The method of claim 1,
wherein each respective per-user FCS of the one or more per-user FCSs is comprised in a respective user info field of the ICF, the respective user info field corresponding to a respective destination wireless device of the ICF.

3. The method of claim 2,
wherein, for a respective per-user FCS of the one or more per-user FCSs, contents of the ICF up to the respective per-user FCS are used to calculate the respective per-user FCS.

4. The method of claim 1, wherein the method further comprises:
selecting a subset of destination wireless devices of the ICF for which to include a per-user FCS, wherein the subset of destination wireless devices of the ICF for which to include a per-user FCS is selected based at least in part on which destination wireless devices of the ICF are ultra-high reliability (UHR) onward devices, enhanced multi-link single radio secondary channel (eMLSR-SC) operation devices, dynamic subband operation (DSO) devices, Non-Primary Channel Access operation devices, or Power Save operation devices.

5. The method of claim 1, wherein the method further comprises:
generating the one or more per-user FCSs using a generator polynomial of degree 32.

6. The method of claim 5, wherein the method further comprises:
extracting, for a respective per-user FCS of the one or more per-user FCSs, 2 bytes of a 4 byte output of the generator polynomial of degree 32 to use as the respective per-user FCS.

7. The method of claim 1, wherein the method further comprises:
generating the one or more per-user FCSs using a generator polynomial of degree 16.

8. The method of claim 1, wherein the ICF further comprises a final FCS and the method further comprises:
generating the final FCS for the ICF, wherein contents of the ICF including the one or more per-user FCSs are used to calculate the final FCS for the ICF.

9. The method of claim 1, wherein the method further comprises:
determining an order for user info fields of the ICF based at least in part on channel switch or operation mode switch padding delay requirements for the plurality of wireless devices.

10. A processor comprising memory storing one or more instructions configured to cause the processor to:
generate an initial control frame (ICF) configured for transmission to a plurality of wireless devices, the ICF comprising one or more per-user frame check sequences (FCSs).

11. The processor of claim 10,
wherein a respective per-user FCS of the one or more per-user FCSs is encoded in a respective user info field of the ICF corresponding to a respective destination wireless device of the ICF, and
wherein, for the respective per-user FCS of the one or more per-user FCSs, contents of the ICF up to the respective per-user FCS are used to calculate the respective per-user FCS.

12. The processor of claim 10, wherein the memory storing one or more instructions is further configured to cause the processor to:
select one or more destination wireless devices of the ICF for which to include a per-user FCS based at least in part on the one or more destination wireless devices of the ICF operating as ultra high reliable (UHR) onward devices, enhanced multi-link single radio secondary channel (eMLSR-SC)/dynamic subband operation (DSO) devices, Non-Primary Channel Access operation devices, or Power Save operation devices.

13. The processor of claim 10, wherein the memory storing one or more instructions is further configured to cause the processor to, for a respective per-user FCS of the one or more per-user FCSs:
generate the respective per-user FCS using a generator polynomial of degree 32; and
extract 2 bytes of a 4 byte output of the generator polynomial of degree 32 to use as the respective per-user FCS.

14. The processor of claim 10, wherein the memory storing one or more instructions is further configured to cause the processor to, for each respective per-user FCS of the one or more per-user FCSs:
generate the respective per-user FCS using a generator polynomial of degree 16.

15. The processor of claim 10, wherein the ICF further comprises a final FCS, wherein the memory storing one or more instructions is further configured to cause the processor to:
generate the final FCS for the ICF, wherein contents of the ICF including the one or more per-user FCSs are used to calculate the final FCS.

16. A method for operation in wireless communication, comprising:
receiving, from an access point (AP) wireless device, an initial control frame (ICF) comprising one or more per-user frame check sequences (FCSs).

17. The method of claim 16,
wherein a respective per-user FCS of the one or more per-user FCSs is encoded in a respective user info field of the ICF corresponding to a respective destination wireless device of the ICF.

18. The method of claim 16, wherein the method further comprises:
performing an FCS check for the ICF using a per-user FCS encoded in a user info field of the ICF.

19. The method of claim 18,
wherein the FCS check for the ICF is performed using contents of the ICF up to the per-user FCS encoded in the user info field of the ICF.

20. The method of claim 16,
wherein the ICF comprises a multi-user (MU) request-to-send (RTS) frame.
